(19) United States
(12) Patent Application Publication
(10) Pub. No.: US 2023/0368933 A1
(43) Pub. Date: Nov. 16, 2023

(54) HIGH ASSAY, LOW ENRICHED URANIUM DECONVERSION PROCESS

(71) Applicant: TerraPower, LLC, Bellevue, WA (US)

(72) Inventor: Clifford James Yeager, Moscow, ID (US)

(21) Appl. No.: 18/302,576

(22) Filed: Apr. 18, 2023

Related U.S. Application Data
(60) Provisional application No. 63/340,893, filed on May 11, 2022.

(51) Int. Cl. G21C 19/44

(52) U.S. Cl. CPC G21C 19/44

(57) ABSTRACT

A novel semi-batch process for deconverting high assay low enriched uranium (HALEU) from its uranium hexafluoride state to uranium dioxide and other chemical states useful as feeds for nuclear fuel in a nuclear reactor is provided. The semi-batch process enables the use of equipment that is small enough, and production rates that are low enough, to meet nuclear criticality safety restraints for HALEU, while enabling the safe, dependable, and economical production of HALEU feed for nuclear fuel at a nominal capacity of up to about 20 MTU (metric tons of uranium metal) per year per deconversion reactor.

### CROSS-REFERENCE TO RELATED APPLICATIONS

This application claims the benefit of U.S. Provisional Patent Application No. 63/340,893, filed May 11, 2022, entitled “HIGH ASSAY, LOW ENRICHED URANIUM DECONVERSION PROCESS”, the contents of which is incorporated herein by reference in its entirety.

### FIELD OF THE DISCLOSURE

This disclosure is directed to an efficient and effective process for deconverting fluorinated HALEU materials to produce HALEU feed for nuclear fuel.

### BACKGROUND

There is currently a need for High-Assay, Low Enriched Uranium (“HALEU”) feed materials to be used in fuel fabrication for advanced nuclear reactors. Uranium enrichment is a process to create effective nuclear fuel out of mined natural uranium by increasing the percentage of the uranium-235 isotope which is capable of undergoing a sustained fission reaction. The enrichment process requires the uranium to be in a gaseous form, which is achieved through a process called conversion. In the conversion process, a uranium oxide (typically uranium trioxide, UO₃) is converted into a different compound, typically uranium hexafluoride (UF₆), which becomes a gas upon heating at relatively low temperatures. Once an enrichment capability is established, the uranium hexafluoride must be deconverted into chemical forms that are useful as feed for the fuel fabricators. Such chemical forms include uranium dioxide (UO₂), triuranium octoxide (U₃O₈), uranium tetrafluoride (UF₄), uranium metal (U), and combinations of the foregoing. For traditional nuclear reactors, the deconverted enriched uranium, typically in powder form, can be pressed into small pellets which are then heated to make a hard ceramic material. The small pellets are inserted into thin tubes called fuel rods, which are grouped together as fuel assemblies and loaded into the reactor core.

Natural uranium from the mines typically contains about 0.7% by weight of the uranium-235 isotope and a balance of the more stable uranium-238 isotope. In the known enrichment process, the UF₆ gas is fed into centrifuges that include thousands of rapidly spinning vertical tubes. The centrifuges separate the UF₆ gas into two streams, one containing a higher percentage (typically 3-5%) of the U-235 isotope and the other containing a very low concentration of U-235. The maximum enrichment of conventional uranium enrichment processes brings the U-235 concentration to less than 5% by weight of the total uranium.

There are two types of deconversion processes for conventional enriched uranium, referred to as a wet process and a dry process. In the wet process, the UF₆ is mixed with water to form a UO₂F₂ solution. Ammonia or ammonium carbonate is added to the mixture. The UO₂F₂ reacts with ammonia to produce ammonium diuranate or with ammonium carbonate to produce ammonium uranyl carbonate. In either case, the slurry is then filtered, dried, and heated in a reducing atmosphere to yield UO₂.

One example of a dry process is described in U.S. Pat. No. 4,830,841, issued to Urza. The described dry process is a continuous process in which the UF₆ is fed to a continuous fluidized bed reactor and is exposed to superheated steam in a vapor phase reaction to produce fine, submicron particles of uranyl fluoride (UO₂F₂). The uranyl fluoride particles are then agglomerated and densified in the fluidized bed of a uranium oxide material which has a uranium to oxygen ratio of 1:2.0 to about 1:2.67. The agglomerated and densified uranyl fluoride is defluorinated and reduced in the fluidized bed to yield a fluoride-containing uranium oxide material having essentially the same composition as that of the fluidized bed. The fluoride-containing uranium oxide material is continuously removed from the fluidized bed reactor and is fed to a separate rotary kiln, where it is treated with steam and hydrogen to yield ceramic grade uranium oxide. The continuous fluidized bed reactor is unable to completely defluorinate the UF₆. The secondary rotary kiln equipped with steam and hydrogen feed lines is needed to remove the remaining fluorine from the fluoride-containing uranium oxide particles that are discharged from the fluidized bed reactor.

As the nuclear power industry becomes more advanced, there is an evolving need for high assay, low enriched uranium (HALEU) that has enrichments greatly in excess of the conventional enrichments of 3-5%. Uranium enrichments of up to about 20% are needed for advanced reactor designs that are smaller, generate more power per unit of volume, and have longer operating cycles and efficiencies compared to conventional nuclear power reactors. The increasing demand for HALEU is accompanied by an evolving need for a deconversion process suitable to provide feed materials for the manufacture of various types of HALEU fuel.

### SUMMARY

Due to nuclear criticality safety restraints, the deconversion of HALEU feed material (UF₆) requires a process that uses much smaller equipment, and which provides safe, dependable, and economical production of HALEU feed for nuclear fuel. For purposes of this disclosure, the term HALEU encompasses any uranium or uranium compound in which the uranium component includes greater than 5% by weight and up to about 20% by weight of the U-235 isotope. Examples of HALEU also include uranium metal and uranium compounds in which the uranium component includes at least about 10% by weight of the U-235 isotope, or at least about 15% by weight of the U-25 isotope, as well as premium commercial HALEU that includes about 19.75% by weight of the U-235 isotope based on the total amount of uranium. All such HALEU uranium and uranium compounds include uranium that has been enriched beyond the 3-5% level for which prior processes were designed. The present process is a semi-batch fluidized bed dry process for the deconversion of fluorinated HALEU material to produce HALEU feed for nuclear fuel. The process can use an order of magnitude smaller equipment than conventional UF₆ deconversion processes, and presently has a nominal capacity of up to about 20 MTU (metric tons of uranium metal) per year per reaction vessel, and higher capacities can be achieved using multiple reaction vessels as described herein. The process accomplishes complete (or nearly complete) defluorination of UF₆ and production of defluorinated uranium oxide in a single fluidized bed reactor, and is devoid of a secondary rotary kiln or other secondary reactor that known fluidized bed dry processes require for complete defluorination to UO₂ powder. A fluidized bed reactor is a type of reactor device in which a fluid (i.e., gas or liquid) is passed through a solid granular material (e.g., powder or larger particulate materials) at high enough velocity to suspend the solid and cause it to behave as though it were a fluid. The solid materials may be partially or completely suspended in the fluid and may be transported along with the fluid.

According to some embodiments, the semi-batch process utilizes an upright fluidized bed reactor vessel which can have a cylindrical shape or another suitable shape. In a first step a), a seed bed of uranium dioxide (UO₂) powder is provided in a lower portion of the upright fluidized bed reactor vessel. The seed bed can have a mass that is between about 5% and about 20% of a target accumulated mass in the fluidized bed reactor. For example, if the fluidized bed reactor has a batch size represented by a target accumulated mass of about 10 kg of UO₂ powder, the seed bed can have a mass of about 0.5 kg to about 2 kg, or suitably about 1 kg to about 1.5 kg. In some examples, the uranium component of the UO₂ powder includes greater than 5% by weight, or at least about 10% by weight, or at least about 15% by weight, or about 19.75% by weight of the U-235 isotope.

In a second step b), the UO₂ powder in the seed bed can be fluidized using an upflow stream of an inert gas which can be fed to a lower portion of the fluidized bed reactor vessel and is heated. As used herein, an “upflow stream” is a flow of gas or liquid that passes through a particulate solid in an upwardly direction and has a tendence to suspend the particulate solid in the fluid stream. The heating can be accomplished by heating both the reaction vessel and the inert gas that is entering the reactor vessel using electric heaters or other sources of heat. The upflow stream of inert gas can be injected at the bottom of the fluidized bed reactor vessel using sufficient velocity and volumetric flow to fluidize the UO₂ powder. The inert gas can be nitrogen, argon, or another suitable inert gas and is suitably nitrogen due to its availability and lower cost. In some examples, the initial heating is sufficient to enable the subsequent conversion of uranium hexafluoride (UF₆) to uranyl fluoride (UO₂F₂), which can occur at a reaction temperature of at least about 400° C., suitably at least about 450° C., and the conversion of UO₂F₂ to UO₂ powder which can occur at a reaction temperature of at least about 600° C. The initial heating in a top portion of the reactor vessel can be to a temperature of at least about 400° C., suitably at least about 450° C., in order to trigger the initial hydrolysis reaction. The initial heating in a bottom portion of the reaction vessel can be to at least about 600° C. to enable the conversion of UO₂F₂ to UO₂ powder to occur.

In a third step c), hydrogen gas and steam may be added to and fed with the upflow stream of inert (e.g., nitrogen) gas in the fluidized bed reactor vessel. This addition can occur at about the same level in the reactor vessel as the nitrogen addition, at the bottom or just below the fluidized bed.

In a fourth step d), vaporized uranium hexafluoride (UF₆), suitably heated to about 100° C., and additional steam are fed in separate streams which in some embodiments can converge into a single entrance nozzle, suitably at a higher location into the fluidized bed reactor vessel. The UF₆ feed is composed of uranium that includes greater than 5% by weight U-235 isotope, or at least about 10% by weight U-235 isotope, or at least about 15% by weight U-235 isotope, or about 19.75% by weight U-235 isotope. The UF₆ feed can be injected higher up in the reactor vessel, for example, in a top portion of the reactor vessel, or at or near the top of the fluidized bed. In some examples, the collective amounts of hydrogen gas and steam are sufficient to carry out the following deconversion reactions in which the UF₆ is first converted to UO₂F₂ at about 450° C. (step e)) and the UO₂F₂ is then converted to UO₂ powder at a temperature of about 600° C. (step f)).

UF₆(g)+2H₂O(g)→UO₂F₂(s)+4HF(g) Step e):

UO₂F₂(s)+2H₂(g)→UO₂(s)+4HF(g) Step f):

The collective amount of steam added to the fluidized bed reactor vessel can exceed the stoichiometric amount required to achieve hydrolysis of the uranium hexafluoride and can, for example, range from about 4 to about 7 moles of steam per mole of uranium. The inert gas such as nitrogen acts as a consistent fluidizing gas and a diluent for the steam and can, for example, range from about 0.5 to about 1.5 moles of inert gas per mole of uranium. The reactor vessel can be heated and/or cooled as needed to sustain both reactions at steady state. For example, the top portion of the reactor vessels may require steady state cooling and the bottom portion of the reactor vessel may require steady state heating.

The UO₂ powder generated in step f) may accumulate in the reactor vessel until a target mass is achieved. In some examples, the target mass can be at least about 3 times the mass of the initial seed bed of UO₂ powder, or at least about 5 times the mass of the initial seed bed of UO₂ powder, or at least about 7 times the mass of the initial seed bed of UO₂ powder. In one example, the initial seed bed of UO₂ powder can have a mass of about 1-2 kg, and the target mass can be about 10 kg. When the UO₂ powder reaches its target mass in the fluidized bed, step g) can be performed in which the feed streams of UF₆ and additional steam may be stopped. At this point, any residual UF₆ in the reactor vessel may be given sufficient time to react with the stream of hydrogen and steam being fed to the bottom of the fluidized bed, yielding additional UO₂ powder which accumulates in the fluidized bed. This step g) can continue until all the HALEU feed material in the fluidized bed reactor vessel has been completely defluorinated or defluorinated to a desired level, leaving substantially or completely defluorinated UO₂ powder in the fluidized bed.

When step g) has been completed, step h) can be performed in which the stream(s) of hydrogen gas and steam entering the bottom of the fluidized bed can be stopped to enable the discharge of a selected quantity of the UO₂ powder from the bottom of the reactor vessel. In some embodiments, a first quantity of the UO₂ powder can be discharged from the reactor vessel to leave behind a second quantity of the UO₂ powder as a seed bed of the UO₂ powder having about the same mass as the seed bed in step a). Steps b) to h) can then be repeated enough times until a desired quantity of fluorinated HALEU material has been deconverted and/or a desired quantity of UO₂ powder has been produced.

In some embodiments, the UO₂ powder discharged from the fluidized bed reactor vessel can be used directly as HALEU feed for nuclear fuel. In other embodiments, the UO₂ powder discharged from the fluidized bed reactor can be converted into different kinds of HALEU feed for nuclear fuel using subsequent fluidized bed reactors that can have the same or similar size and construction as the semi-batch fluidized bed reactor used to produce the UO₂ powder.

In some embodiments, the UO₂ powder can be discharged from the fluidized bed reactor vessel and fed to a second fluidized bed reactor vessel and fluidized in the presence of a source of oxygen, suitably air. The fluidized bed can then be heated to a temperature of at least about 140° C., suitably by heating the incoming air simultaneously with the second reactor vessel. When the fluidized bed temperature reaches about 140° C., an exothermic reaction commences and can continue as the temperature increases up to about 500° C., until all of the UO₂ powder has been converted into triuranium octoxide (U₃O₈) according to the following reaction:

3UO₂(s)+O₂(g)→U₃O₈(s)

The source of air can then be stopped or slowed, and the second reactor vessel can be cooled or permitted to cool enough to enable removal of the U₃O₈ powder from the second fluidized bed reactor. The U₃O₈ is useful as feed for nuclear fuel in some applications.

In some embodiments, the UO₂ powder can be discharged from the fluidized bed reactor vessel, fed to a second fluidized bed reactor vessel. The UO₂ powder is then fluidized in the second reactor vessel using an inert gas such as nitrogen and the upflow stream is heated to a temperature of about 400° C. to about 500° C., suitably by heating both the incoming nitrogen stream and the second reactor vessel. Hydrogen fluoride gas is added to the second fluidized bed reactor, which in turn reacts with the UO₂ powder to yield uranium tetrafluoride (UF₄) according to the following reaction:

UO₂(s)+4HF(g)→UF₄(s)+2H₂O(g)

Care can be taken not to significantly exceed the amount of HF needed to complete the reaction, and to properly vent any residual HF that may remain when the reaction is complete. The resulting UF₄ powder is in the form of a green salt and can be discharged into suitable containers and used as feed for nuclear fuel in some applications.

In some embodiments, the foregoing UF₄ powder can be reacted with an alkali metal, suitably calcium, to yield uranium metal. This reaction can occur in a pressure and temperature-resistant vessel which has been heated to a temperature of at least about 400° C. In some embodiments, the UF₄ powder and alkali metal (e.g., calcium) powder can be mixed together and placed in a pressure and temperature-resistant vessel known as a “bomb reactor.” The vessel is heated until the exothermic reaction is initiated, after which the following exothermic reaction can drive the temperature up to about 1400° C. as the reaction proceeds to completion:

UF₄(s)+2Ca(m)→U(m)+2CaF₂(s)

The uranium metal drops to the bottom of the vessel, forming a pool of pure metal. The CaF2 collects as “slag” above the metal. After the reaction vessel has been cooled or allowed to cool, the vessel may be opened, and the slag can be separated from the metal. The pure uranium metal is useful as feed for nuclear fuel in some applications.

The foregoing and other features and advantages will become further apparent from the following Detailed Description, read in conjunction with the drawings.

### BRIEF DESCRIPTION OF THE DRAWINGS

FIG. 1 schematically illustrates some embodiments of a semi-batch fluidized bed reactor that is suitable for carrying out the process for producing HALEU UO₂ powder by deconversion of fluorinated HALEU feed material, for example, UF₆. The illustrated semi-batch fluidized bed reactor is also representative of the secondary fluidized bed reactors that can be used to convert the HALEU UO₂ powder to other HALEU feeds for nuclear fuels, including U₃O₈ and UF₄.

FIG. 2 schematically illustrates some embodiments of a semi-batch secondary fluidized bed reactor that can be used to convert the HALEU UO₂ powder from the primary fluidized bed reactor to another HALEU feed for nuclear fuel, including U₃O₈.

FIG. 3 schematically illustrates some embodiments of a semi-batch secondary fluidized bed reactor that can be used to convert the HALEU UO2 powder from the primary fluidized bed reactor to another HALEU feed for nuclear fuel, including UF4, which product can either be used directly as feed for nuclear fuel or to produce uranium metal feed, according to some embodiments.

FIG. 4 schematically illustrates the process steps of the disclosure in a block diagram format, according to some embodiments.

### DETAILED DESCRIPTION

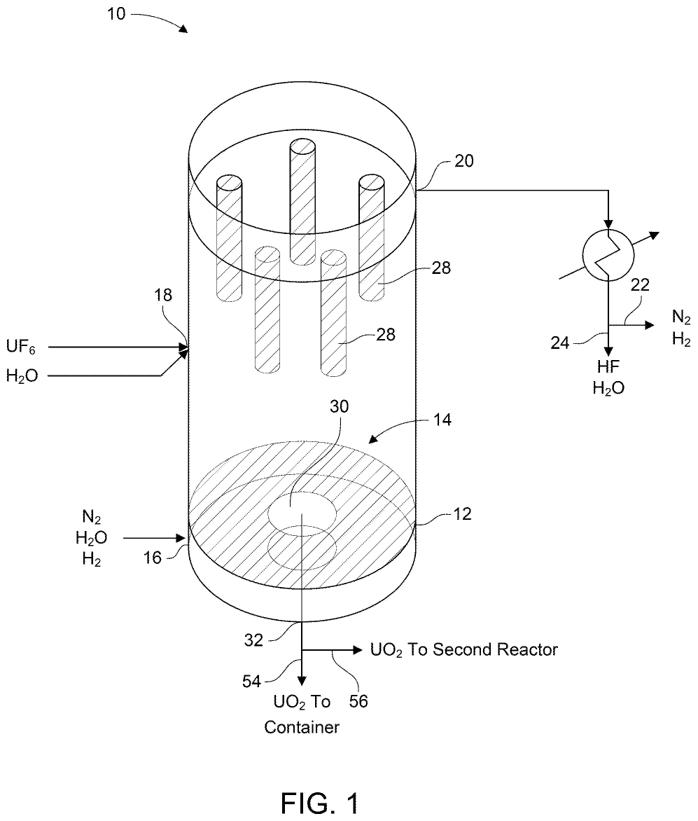

Referring to FIG. 1, a semi-batch process for deconverting fluorinated HALEU material includes a semi-batch fluidized bed reactor 10 which can have a much smaller size than continuous dry processes used for the deconversion of conventional low-assay uranium-based feed materials. The fluidized bed reactor 10 can have any suitable shape including without limitation the illustrated cylindrical shape, and can have a volume that is capable of producing about 5 kg to about 20 kg, suitably about 10 kg to about 15 kg of HALEU UO₂ powder in a single batch. The volume of the reactor 10 can be approximately 90 percent smaller than conventional volumes of continuous, dry process fluidized bed reactors that are used for the deconversion of conventional low-assay uranium-based feed materials.

In some examples, the fluidized bed reactor 10 includes a gas distributor plate 12, which can be a sintered metal plate having a central opening 30, and is used to inject evenly distributed fluidizing gas near the bottom of the fluidized bed reactor 10. In the first step a), a seed bed 14 of HALEU uranium dioxide powder (described above) is provided on top of the gas distributor plate 12. This can be accomplished, for example, using a vertical pipe (not shown) extending upward through the central opening 30. As a non-limiting example, for a 10 kg batch, the seed bed can have a mass of about 0.5 kg to about 2 kg, or about 1 kg to about 1.5 kg. In the second step b), a fluidizing stream of an inert gas, suitably nitrogen, is fed to the gas distribution plate 12 at an injection point 16 below the gas distributor plate, at a sufficient velocity and volumetric flow rate to fluidize the seed bed 14. The fluidizing stream provides an upflow stream that flows from the bottom to the top of the fluidized bed reactor 10.

The reactor vessel is heated, suitably by heating both the inert gas stream and the fluidized bed reactor 10, to a temperature sufficient to cause the defluorination reactions to take place in the desired temperature ranges of at least about 400-450° C. for the conversion of UF₆ to uranyl fluoride and at least about 600° C. for the conversion of uranyl fluoride to UO₂ powder. Initially, this may require different amounts of heat to be applied in a bottom portion of the fluidized bed reactor 10, which can be initially heated to at least about 600° C., and in a top portion of the reactor 10, which can be initially heated to at least about 400° C. Because the reactions taking place can be a combination of exothermic and endothermic, steady state operation may require an ongoing removal of heat near the top and an ongoing addition of heat near the bottom of the fluidized bed reactor 10. In the third step c), as the upflow stream is being heated, steam and hydrogen gas can be added to the upflow stream at the same injection point 16 as the inert gas or close to it.

When the reactor vessel has reached a suitable reaction temperature, in the fourth step d), separate streams of vaporized UF₆ and steam are added at a second injection point 18 (or two injection points at about the same location), whereupon the injection point(s) 18 are significantly higher in the reactor vessel that the first injection point 16. The injection point(s) 18 can be located above the top of the fluidized bed 14. The amount of hydrogen gas added at the first injection point 16 and the collective amounts of steam added at the first and second injection points 16 and 18 should be sufficient to carry out the following deconversion reactions. First, the UF₆ is converted to UO₂F₂ at about 450° C. in the fifth step e) according to the following reaction.

UF₆(g)+2H₂O(g)→UO₂F₂(s)+4HF(g) Step e):

Second, the UO₂F₂ is converted to UO₂ powder at a temperature of about 600° C. in the sixth step f) according to the following reaction.

UO₂F₂(s)+2H₂(g)→UO₂(s)+4HF(g) Step f):

While there can be some overlap in the performance of steps e) and f), the two reactions commence at different temperatures and can initiate at different locations in the reactor vessel. The reaction that yields uranyl fluoride (step e)) commences at about 450° C. when the UF₆ is combined with steam in the entrance nozzle and added to the reactor, while the reaction that converts uranyl fluoride to uranium dioxide (step f)) commences at about 600° C. as the UO₂F₂ is being formed and is contacted with hydrogen. As the uranyl fluoride is being formed, it initially accumulates on a plurality of sintered metal filters 28 located at the top of the fluidized bed reactor 10, forming a cake on the filter surfaces. The cake is periodically discharged from the filters 28 using a nitrogen blowback which dislodges the uranyl fluoride and drops it back into the fluidized bed. As the process cycle continues, the dislodged uranyl fluoride becomes incorporated into the fluidized bed and reacts with the hydrogen gas to form the uranium dioxide (step f)) as the temperature in the upflow stream approaches 600° C.

The collective amounts of steam added to the fluidized bed reactor vessel in both injection points 16 and 18 can exceed the stoichiometric amount required to achieve hydrolysis of the uranium hexafluoride as explained above. The inert gas such as nitrogen serves as a fluidizing gas and acts as a diluent for the steam. The amount of hydrogen added should be as close as possible to what is needed to complete the conversion of uranyl fluoride to uranium dioxide and can be increased as necessary if the defluorination is less than complete, or is less than a desired target amount. Each of the two reactions generates hydrogen fluoride (HF) by-product which exits the off-gas outlet 20 along with the nitrogen and any excess steam and hydrogen. The hydrogen fluoride mixes with the excess steam to form hydrofluoric acid which condenses and separates from the nitrogen and hydrogen gas, resulting in separate streams 22 and 24. The nitrogen and hydrogen gas can be disposed of or recycled, while the hydrofluoric acid can be sold for other industrial uses.

As the uranium dioxide product is formed in step f), it accumulates as a powder and becomes part of the fluidized bed. The mass of the fluidized bed therefore increases until it reaches a target mas which can be at least about three times, or at least about five times, or at least about seven times or more, compared to the mass of the initial seed bed. For example, the fluidized bed reactor 10 can be sized to operate with a seed bed of about 1-2 kg of uranium dioxide powder and a target mass of about 10 kg. When the fluidized bed reaches the target mass, step g) is performed which includes stopping the inlet feed of UF₆ into the fluidized bed reactor 10 and allowing all remaining UF₆ in the reactor 10 to react with the stream of hydrogen and steam to first form uranyl fluoride (UO₂F₂) and then uranium dioxide (UO₂) powder, which accumulates in the fluidized bed. Step g) can be allowed to continue until the fluidized bed contains essentially pure UO₂ powder and is essentially devoid of fluorinated intermediate products, at which point the initial batch of UF₆ feed has been completely defluorinated or has been defluorinated to a desired level.

When the batch of UF₆ has been completely defluorinated or defluorinated to a desired level in the fluidized bed reactor 10, the seventh step g) is performed, which includes stopping the feed stream of hydrogen and steam in the first inlet 16 to enable discharge of a quantity of UO₂ powder through the center opening 30 in the gas distribution plate 12 and through the discharge outlet 32 at the bottom of the fluidized bed reactor 10. The inlet flow of nitrogen can be increased as needed to maintain enough fluidization to facilitate the discharge. The quantity of UO₂ powder that is discharged can be just enough to leave behind a seed bed of UO₂ powder to aid in processing the next batch of UF₆ feed and can be about 80% to about 95% of the accumulated or target mass in the fluidized bed reactor 10. The UO₂ powder that is discharged through the outlet 32 can be fed to either or both of two streams 34 and 36. The illustrated stream 34 leads to a storage container whereupon the UO₂ powder can be used directly as feed for nuclear fuel in some applications. The illustrated stream 36 leads to a second fluidized bed reactor whereupon the UO₂ powder can be converted to other feeds for nuclear fuels useful for some applications, including without limitation U₃O₈, UF₄, and (following the conversion to UF₄) to uranium metal.

When step g) has been completed, leaving behind enough UO₂ powder to replenish the seed bed, steps b)-h) can be repeated using a new batch of UF₆ feed. The process can be repeated as many times as needed to produce enough UO₂ powder to meet ongoing needs. The nominal capacity of a single fluidized bed reactor as described above, operating with a target mass of 10 kg UO₂ powder, is estimated to be about 20 MTU per year. The production rate can be increased by arranging several of the fluidized bed reactor vessels 10 in parallel, whereupon each one can contribute an annual production capacity of about 20 MTU per year.

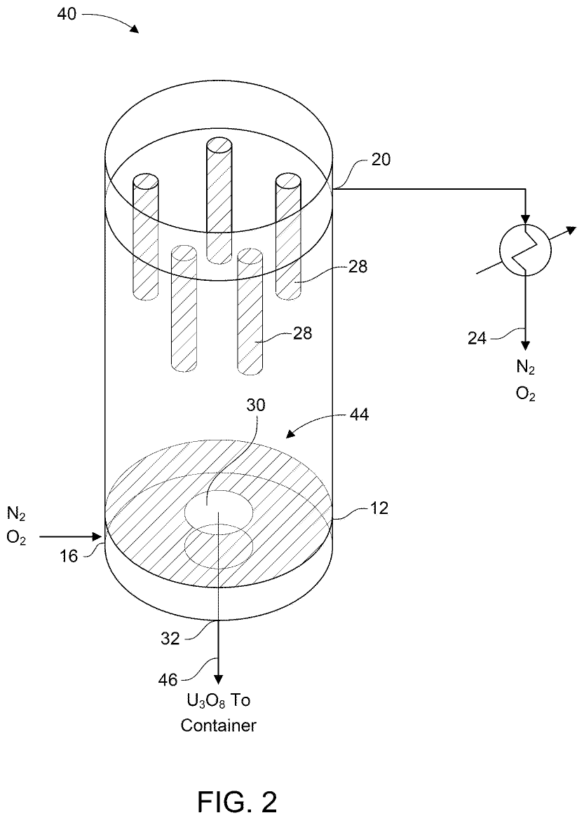

FIG. 2 schematically illustrates how an identical or very similar second semi-batch fluidized reactor 40 can be used to convert a batch of UO₂ powder from the first fluidized bed rector 10 into triuranium octoxide (U₃O₈) feed for nuclear fuel. Referring to FIG. 2, the gas distributor plate 12 can be loaded with a full batch of UO₂ powder from the first reactor 10, for example, a batch having a mass of approximately 10 kg, to form a bed 44 above the distributor plate 12. The bed can be fluidized using air, which contains 79% nitrogen and 21% oxygen, entering the inlet 16 just below the distribution plate 12. The oxidation vessel is heated to a temperature of about 140° C., suitably by heating both the incoming air and the second fluidized bed reactor 40, to commence the exothermic reaction. Once the exothermic reaction commences, the temperature can increase rapidly up to about 500° C., The following exothermic reaction proceeds quickly until all of the UO₂ powder has been converted to U₃O₈ powder:

3UO₂(s)+O₂(g)→U₃O₈(s)

Any U₃O₈ powder that accumulates on the sintered filters 28 can be blown off using air or nitrogen. When the reaction is complete, the source of heat can be shut off and, after cooling, the U₃O₈ powder can be discharged from the second fluidized bed reactor through the opening 30, outlet 32 and stream 46 leading to a storage container.

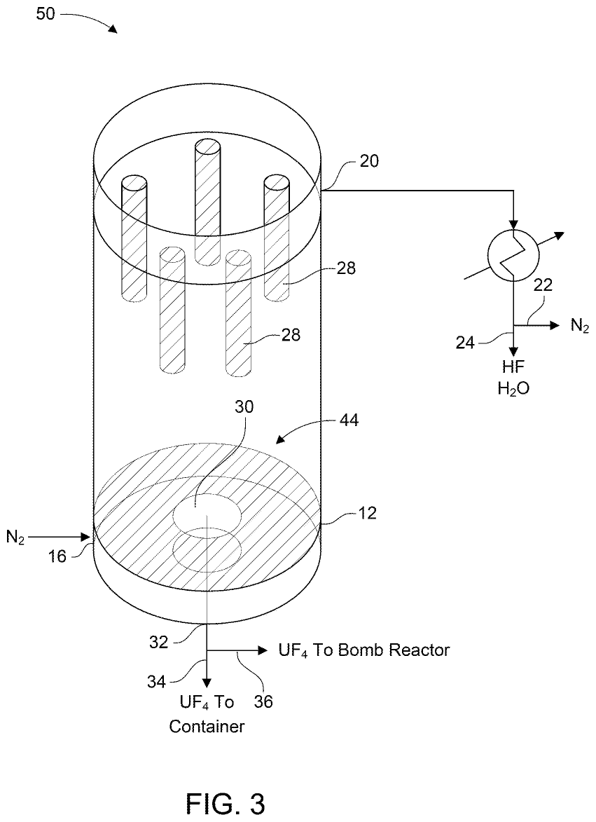

FIG. 3 schematically illustrates how an identical or very similar second semi-batch fluidized reactor 50 can be modified to convert a batch of UO₂ powder from the first fluidized bed rector 10 into uranium tetrafluoride (HF₄) which can then be used directly as feed for nuclear fuel or converted into uranium metal feed in a subsequent process. Referring to FIG. 3, the gas distributor plate can be loaded with a full batch of UO₂ powder from the first reactor 10, for example, a batch having a mass of approximately 10 kg, to form a bed 44 above the distributor plate 12. The bed can be initially fluidized using a nitrogen upflow stream which enters the inlet 16 just below the distribution plate 12. As the upflow stream is heated to a reaction temperature of about 400° C. to about 500° C., suitably by heating both the incoming nitrogen stream and the reactor vessel 50, hydrogen fluoride gas can be metered into the upflow stream in the fluidized bed to convert the UO₂ powder to HF₄ according to the following reaction:

UO₂(s)+4HF(g)→UF₄(s)+2H₂O(g)

The off-gas including nitrogen, steam from the reaction and residual HF exits the reactor through outlet 20. The exit stream then splits into a gas stream 22 of nitrogen gas and a liquid stream 24 of hydrofluoric acid formed by the mixing of HF gas with condensing steam. The UF₄ product exists as a green salt which is discharged from the fluidized bed reactor vessel 50 via opening 30 and discharge outlet 32. The discharge stream of UF₄ that is discharged through the outlet 32 can be fed to either or both of two streams 54 and 56. The illustrated stream 54 leads to a storage container whereupon the UF₄ salt can be used directly as feed for nuclear fuel in some applications. The illustrated stream 56 leads to a closed vessel “bomb reactor” where the UF₄ salt can be reacted with calcium metal to yield uranium metal. The bomb reactor can be lined with an inert material such as magnesium oxide. The reaction can be initiated at a temperature of about 400° C. until the exothermic reaction is initiated, after which the following exothermic reaction can drive the temperature up to about 1400° C. as the reaction proceeds to completion:

UF4(s)+2Ca(m)→U(m)+2CaF₂(s)

Assuming a starting batch of about 10 kg UF₄ salt, the reaction in the bomb reactor typically yields about 8 kg of uranium metal and about 2 kg of calcium fluoride slag which can be separated from the uranium. The uranium metal can then be used as feed for nuclear fuel in some applications.

The illustrated fluidized bed reactor vessel 10 provides a highly effective and efficient small reactor that meets nuclear safety standards for the deconversion of fluorinated HALEU feed material into a variety of useful HALEU feeds for nuclear fuels. In one example, the reactor vessel 10 may have a diameter of only about 4-5 inches with a somewhat expanded vapor space at the top to aid in disengagement of the fluidized powder from the sintered metal filters. Two virtually identical reactor vessels of the same size and construction can be provided in series to convert the UO₂ powder to a variety of alternative HALEU feeds for nuclear fuels. Because the fluidized bed reactor vessel is an order of magnitude (about 90%) smaller than conventional continuous dry process deconversion reactors, it is especially suited for the deconversion of fluorinated HALEU feed material.

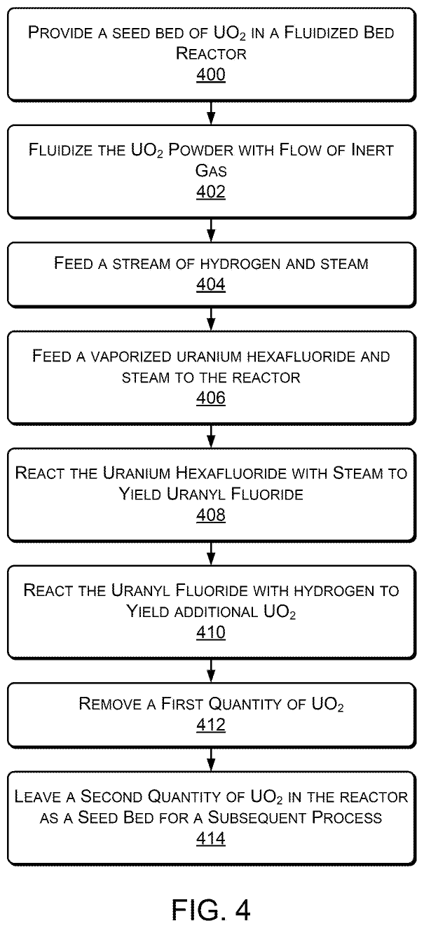

FIG. 4 illustrates an example process flow of deconverting UF₆ to UO₂ through a batch or semi-batch process, as described throughout the various embodiments presented herein. As described above in the various embodiments, at block 400, a seed bed of UO₂ is provided in a fluidized bed reactor, the seed bed of UO₂ comprising uranium that includes greater than 5% by weight U-235 isotope. At block 402, the UO₂ is fluidized with a flow of an inert gas, which may be nitrogen. At block 404, a stream of hydrogen and steam are fed into the reactor. At block 406, a vaporized uranium hexafluoride and additional steam are fed to the reactor as described above, the vaporized uranium hexafluoride comprising uranium that includes greater than 5% by weight of the U-235 isotope. At block 408, the uranium hexafluoride is reacted with the steam to yield uranyl fluoride. At block 410, the uranyl fluoride is reacted with hydrogen to yield additional UO₂. At block 412, a first quantity of UO₂ is removed from the reactor leaving behind a second quantity of UO₂ to be used as a seed bed for a subsequent batch process at block 414. In some cases, the first quantity of UO₂ removed from the reactor includes uranium having greater than 5% by weight of the U-235 isotope, or greater than 10%, or greater than 15%, or greater than 17%, or greater than 19%.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Unless otherwise noted, the terms “a” or “an,” as used in the specification, are to be construed as meaning “at least one of” Finally, for ease of use, the terms “including” and “having” (and their derivatives), as used in the specification, are interchangeable with and have the same meaning as the word “comprising.”

From the foregoing, and the accompanying drawings, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A semi-batch process for deconversion of fluorinated HALEU material to produce HALEU feed for nuclear fuel, comprising the following steps:
a) providing a seed bed of uranium dioxide (UO₂) powder in a fluidized bed reactor vessel, wherein the UO₂ powder comprises uranium that includes greater than 5% by weight U-235 isotope;
b) fluidizing the UO₂ powder in the reactor vessel using an upflow stream comprising an inert gas, while heating the reactor vessel;
c) feeding a stream of hydrogen and steam to the upflow stream of inert gas;
d) feeding vaporized uranium hexafluoride (UF₆) and additional steam to the fluidized bed reactor vessel, wherein the UF₆ comprises uranium that includes greater than 5% by weight U-235 isotope;
e) reacting the UF₆ with some of the steam to yield uranyl fluoride (UO₂F₂);
f) reacting the UO₂F₂ with the hydrogen in the upflow stream to yield additional UO₂ powder which accumulates in the fluidized bed;
g) stopping, when the UO₂ in the fluidized bed reaches a target mass, the feeding of UF₆ and additional steam and allowing any residual UF₆ in the reactor vessel to react with the stream of hydrogen and steam to yield additional UO₂ powder which accumulates in the fluidized bed; and
h) stopping the stream of hydrogen and steam to enable discharge of a quantity of the UO₂ powder from the reactor vessel.

2. The process of claim 1, further comprising the steps of discharging enough of the UO₂ powder from the reactor vessel to leave behind a seed bed of UO₂ powder as in step a), and repeating steps b) to h).

3. The process of claim 1, wherein the target mass in step g) is at least about three times a mass of the seed bed in step a).

4. The process of claim 1, wherein the target mass in step c) is at least about five times a mass of the seed bed in step a).

5. The process of claim 1, wherein the uranium in steps a) and d) includes greater than about 10% by weight U-235 isotope.

6. The process of claim 1, wherein the uranium in steps a) and d) includes greater than about 15% by weight U-235 isotope.

7. The process of claim 1, wherein the inert gas in step b) comprises nitrogen.

8. The process of claim 1, wherein the heating in step b) is sufficient to enable performing step e) at a temperature of at least about 450° C.

9. The process of claim 1, wherein the heating in step b) is sufficient to enable performing step f) at a temperature of at least about 600° C.

10. The process of claim 1, further comprising the steps of discharging the quantity of UO₂ powder from the reactor vessel and reacting the discharged UO₂ powder with oxygen to yield triuranium octoxide (U₃O₈).

11. The process of claim 10, wherein the reacting of the discharged UO₂ powder with oxygen to yield U₃O₈ is performed in a second fluidized bed reactor vessel at a temperature of at least about 140° C.

12. The process of claim 1, further comprising the steps of discharging the quantity of UO₂ powder from the reactor vessel and reacting the discharged UO₂ powder with hydrogen fluoride gas to yield uranium tetrafluoride (UF₄).

13. The process of claim 12, wherein the reacting of the discharged UO₂ powder with hydrogen fluoride gas to yield UF₄ is performed in a second fluidized bed reactor vessel at a temperature of about 400° C. to about 500° C.

14. The process of claim 12, further comprising the step of reacting the UF₄ with an alkali metal to yield uranium metal (U).

15. The process of claim 14, wherein the alkali metal comprises calcium (Ca) and the reacting of UF₄ with calcium is performed in in a pressure and temperature-resistant vessel at a temperature of at least about 400° C.

16. A semi-batch process for deconversion of fluorinated HALEU material to produce HALEU feed for nuclear fuel, comprising the following steps:
a) providing a seed bed of uranium dioxide (UO₂) powder in a fluidized bed reactor vessel, wherein the UO₂ powder comprises uranium that includes at least about 10% by weight U-235 isotope;
b) fluidizing the UO₂ powder in the reactor vessel using an upflow stream comprising nitrogen gas, while heating the reactor vessel to a temperature of at least about 450° C. in a top portion of the reactor vessel and 600° C. in a bottom portion of the reactor vessel
c) feeding a stream of hydrogen and steam into the upflow stream of inert gas;
d) feeding vaporized uranium hexafluoride (UF₆) and additional steam in the top portion of the fluidized bed reactor vessel, wherein the UF₆ comprises uranium that includes at least about 10% by weight U-235 isotope;
e) hydrolyzing the UF₆ in an upper portion of the fluidized bed reactor vessel to yield uranyl fluoride (UO₂F₂);
f) reacting the UO₂F₂ with the hydrogen in the upflow stream to yield additional UO₂ powder which accumulates in the fluidized bed;
g) stopping, when the UO₂ in the fluidized bed reaches a target mass, the feeding of UF6 and additional steam and allowing any residual UF₆ in the reactor vessel to react with the stream of hydrogen and steam to yield additional UO₂ powder which accumulates in the fluidized bed; and
h) stopping the stream of hydrogen and steam to enable discharge of a quantity of the UO₂ powder from the reactor vessel.

17. The process of claim 16, further comprising the steps of collecting the UO₂F₂ formed in step e) using a sintered metal filter located near the top of the reactor vessel, and periodically blowing the UO₂F₂ off of the filter using nitrogen blowback of the filter, causing the UO₂F₂ to drop toward the fluidized bed.

18. The process of claim 17, wherein the step f) of reacting the UO₂F₂ with the hydrogen in the upflow stream occurs in the fluidized bed.

19. The process of claim 16, wherein the uranium in steps a) and d) includes at least about 15% by weight U-235 isotope.

20. A semi-batch process for deconversion of fluorinated HALEU material to produce HALEU feed for nuclear fuel, comprising the following steps:
a) providing a seed bed of uranium dioxide (UO₂) powder in a fluidized bed reactor vessel, wherein the UO₂ powder comprises uranium that includes about 19.75% by weight U-235 isotope;
b) fluidizing the UO₂ powder in the reactor vessel using an upflow stream comprising an inert gas, while heating the reactor vessel;
c) feeding a stream of hydrogen and steam to the upflow stream of inert gas;
d) feeding vaporized uranium hexafluoride (UF₆) and additional steam to the fluidized bed reactor vessel, wherein the UF₆ comprises uranium that includes about 19.75% by weight U-235 isotope;
e) reacting the UF₆ with some of the steam to yield uranyl fluoride (UO₂F₂);
f) reacting the UO₂F₂ with the hydrogen in the upflow stream to yield additional UO₂ powder which accumulates in the fluidized bed;
g) stopping, when the UO₂ in the fluidized bed reaches a target mass, the feeding of UF₆ and additional steam and allowing any residual UF₆ in the reactor vessel to react with the stream of hydrogen and steam to yield additional UO₂ powder which accumulates in the fluidized bed; and
h) stopping the stream of hydrogen and steam to enable discharge of a quantity of the UO₂ powder from the reactor vessel.

21. The process of claim 20, further comprising the steps of discharging enough of the UO₂ powder from the reactor vessel to leave behind a seed bed of UO₂ powder as in step a), and repeating steps b) to h).
